(19) United States
(12) Patent Application Publication
(10) Pub. No.: US 2009/0056041 A1
(43) Pub. Date: Mar. 5, 2009

(54) Self-sustaining multi-collapsible loading ramp

(76) Inventor: Jeremy W. Wilson, Thayer, MO (US)

Correspondence Address: Jonathon A. Bay;Attorney at Law, 333 Park Central East, Suite 314, Springfield, MO, 65806, US

(21) Appl. No.: 12/290,070

(22) Filed: Oct. 27, 2008

Related U.S. Application Data
(63) Continuation-in-part of application No. 12/221,559, filed on Aug. 4, 2008.
(60) Provisional application No. 60/963,107, filed on Aug. 2, 2007.

(51) Int. Cl. B65G 69/28

(52) U.S. Cl. 14/71.1

(57) ABSTRACT

A self-sustaining multi-collapsible loading ramp has a pair of left and right wing units which each has a leg panel and a deck panel. The two deck panels have a folding connection between their inboard edges so the deck panels can fold between folded-up in parallel adjacent planes to folded out in a common plane. Each same-side leg and deck panel has a folding connection between their inner longitudinal edges so that they can fold between folded-up in parallel adjacent planes to folded out in an inverted-V shape. Each same-side leg and deck panel being provided with a strut so that the ramp as a whole in the fully-folded out state has a symmetric to asymmetric A-frame construction so that a transfer load can traverse across the ramp's deck panels reversibly between a high ground and a low ground.

### CROSS-REFERENCE TO RELATED APPLICATION(S)

This application is a continuation-in-part of U.S. patent application Ser. No. 12/221,559, filed Aug. 4, 2008, which claims the benefit of U.S. Provisional Application No. 60/963,107, filed Aug. 2, 2007.

### BACKGROUND AND SUMMARY OF THE INVENTION

The invention generally relates to loading ramps and, more particularly, to such ramps used to load a relatively smaller, motorized recreational vehicle onto and/or off of the bed of a relatively larger, over-the-road hauling vehicle. A non-limiting example includes ramps for loading all-terrain-vehicles (ATV's) onto and off of the beds of pick-up trucks.

A number of additional features and objects will be apparent in connection with the following discussion of the preferred embodiments and examples with reference to the drawings.

### BRIEF DESCRIPTION OF THE DRAWINGS

There are shown in the drawings certain exemplary embodiments of the invention as presently preferred. It should be understood that the invention is not limited to the embodiments disclosed as examples, and is capable of variation within the scope of the skills of a person having ordinary skill in the art to which the invention pertains. In the drawings,

FIG. 1 is a perspective view of a self-sustaining multi-collapsible loading ramp in accordance with the invention, wherein a non-limiting example use thereof is shown for illustrative purposes only;

FIG. 2 is a side elevational view of FIG. 1 wherein the representations in dashed lines show the adjustability of the ramps configuration;

FIGS. 3 through 6 are a sequence of comparable perspective views showing various transitional stages from taking the ramp from the fully outspread state to the fully folded-up (eg., collapsed) state, wherein—:

FIG. 3 shows in solid lines the ramp in the fully outspread state, and illustrates in dashed lines the transition to the left leg panel being folded under the left main-deck panel,

FIG. 4 illustrates in dashed lines the transition to the left main-deck panel (with left leg panel joining along) being folded onto the right main-deck panel,

FIG. 5 illustrates in dashed lines the transition to the right leg panel being folded under the right main-deck panel, and

FIG. 6 illustrates in solid lines the transition to the ramp in accordance with the invention being in the fully folded-up state;

FIG. 7 is an enlarged scale perspective view of detail VII-VII in FIG. 1;

FIG. 8 is an enlarged scale perspective view of detail VIII-VIII in FIG. 1;

FIG. 9 is an enlarged scale perspective view of detail in FIG. 7, except of an alternate embodiment in accordance with the invention of the hitch post thereof; and

FIG. 10 is a perspective view comparable to FIG. 9 except showing a retracted position for the hitch post.

### DETAILED DESCRIPTION OF THE PREFERRED EMBODIMENTS

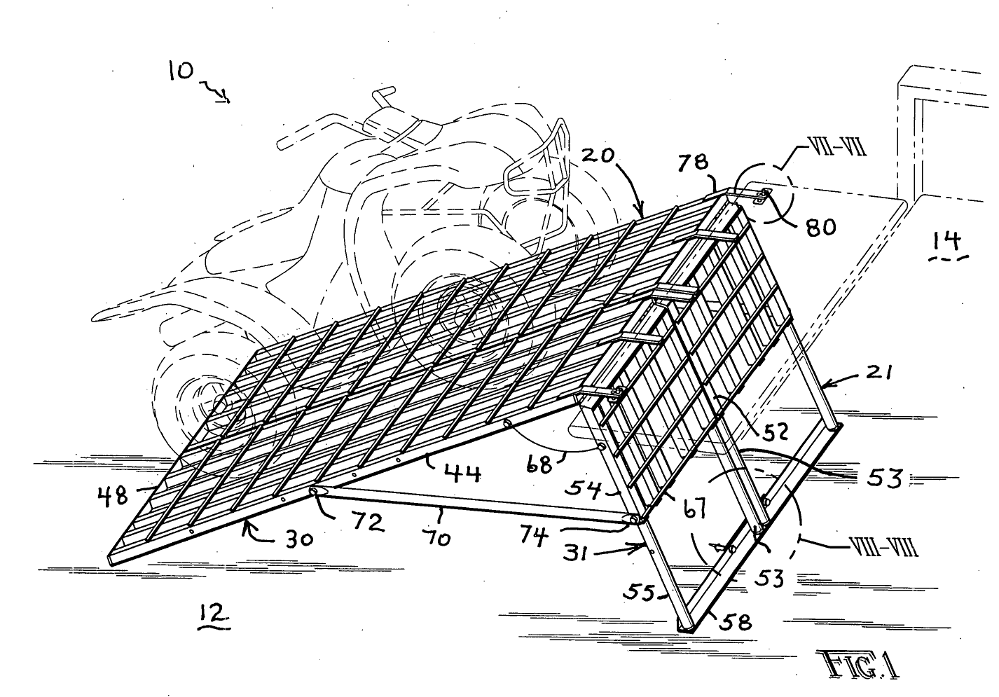

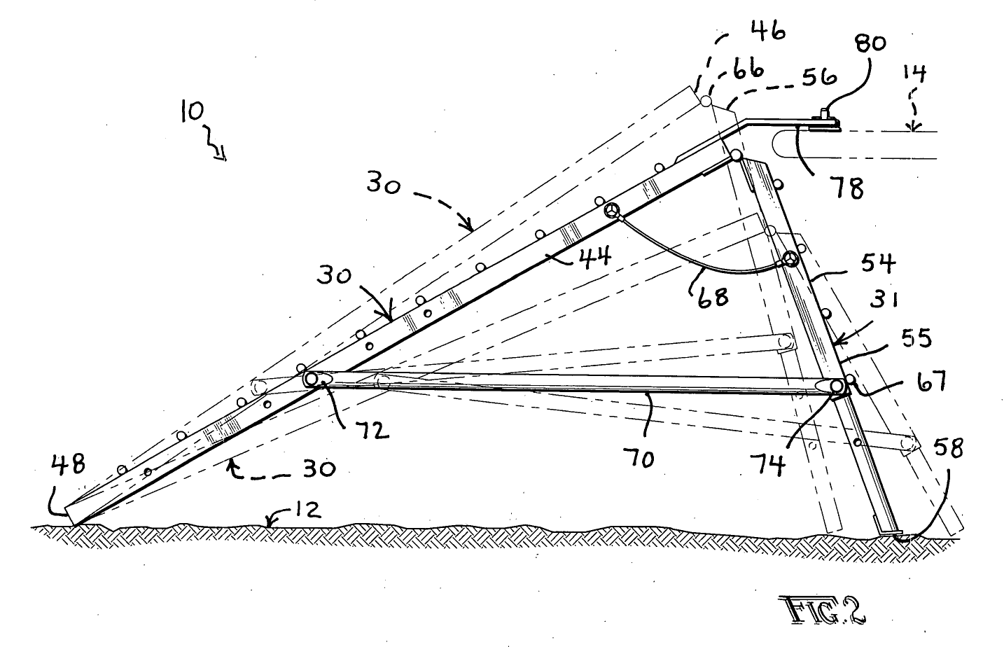

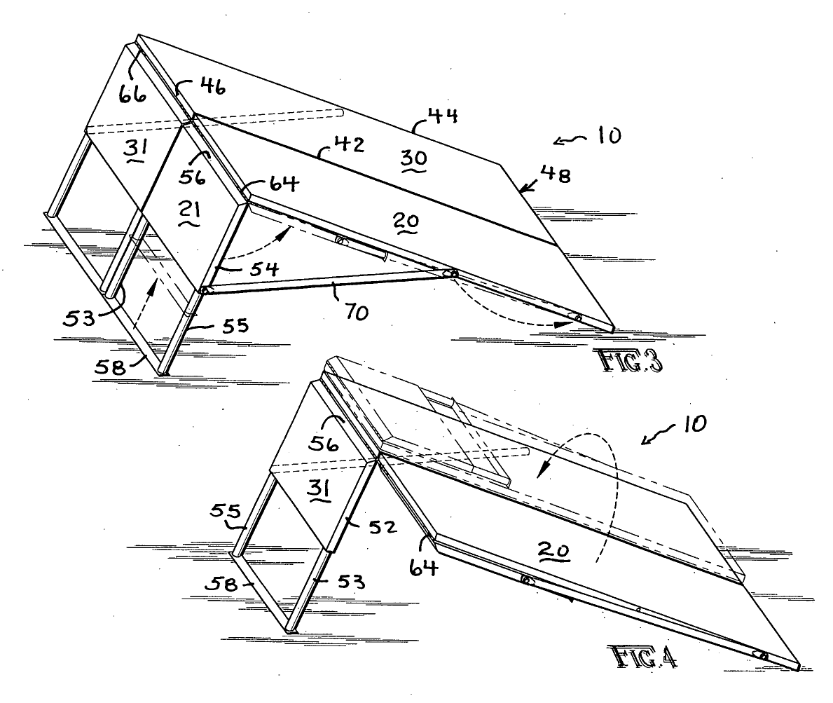

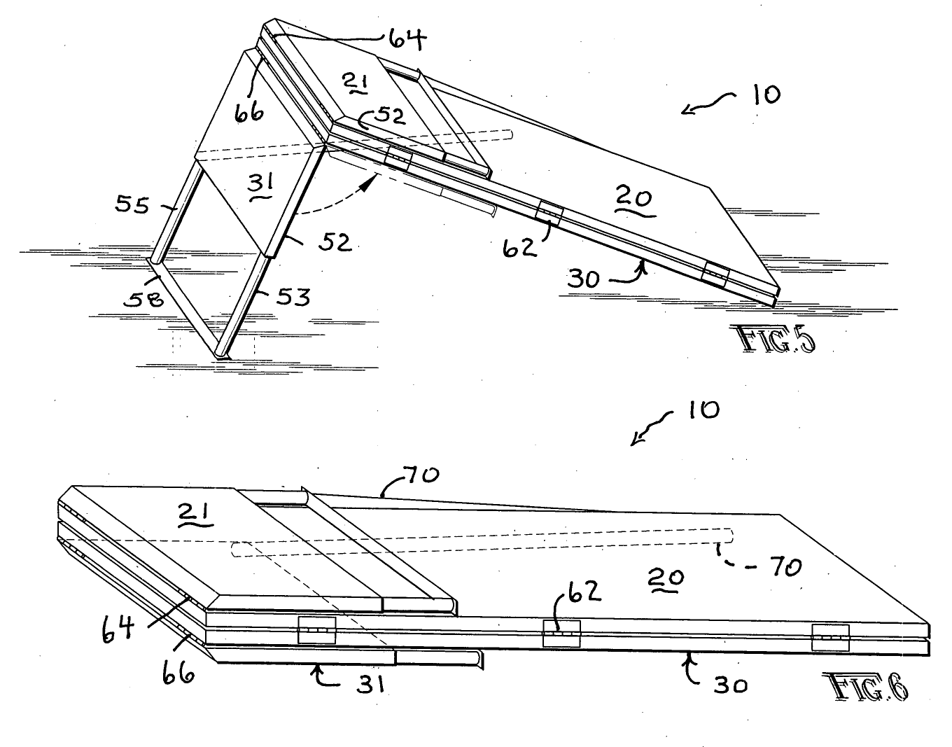

FIGS. 1 and 2 show a self-sustaining multi-collapsible loading ramp 10 in accordance with the invention in a fully outspread state, as for use. Conversely, FIG. 6 show the inventive self-sustaining loading ramp 10 in a fully collapsed or folded-up state, as for storage or transport during non-use. FIG. 3 through 5 are a sequence of views showing (slide show style) various transitional stages from taking the ramp 10 from the fully outspread state to the fully folded-up (eg., collapsed) state. Essentially, the ramp 10 is convertible between a range of collapsed states (eg., FIGS. 4 through 6) and a range of outspread use states (eg., FIG. 2).

The ramp 10 serves as a loading ramp (needless to say) for a transfer load to traverse between a low ground 12 and a high ground 14. Indeed, FIG. 1 shows an example use of the ramp 10, as in connection with an all-terrain-vehicle (ATV). The loading ramp 10 serves as a temporary wheel track between the low elevation 12 and the high elevation 14 for the ATV (eg., transfer load) to cross. In FIG. 1, the low elevation 12 is typically street level. Most often, the intended high elevation 14 is the shelf-like projection of a pickup truck's dropped tailgate.

Whereas FIG. 1 the shows the ramp 10 in use in connection with an ATV, this is an example merely for sake of illustration and does not otherwise limit the invention as the ramp 10 is useful for riding lawnmowers, golf carts, motorcycles and so on—without limitation—including non-vehicular transfer loads.

With general reference to the views, the ramp 10 generally comprises an assembly of four panels 20-21 and 30-31. Preferably but without limitation the panels 20-21 and 30-31 comprise a frame construction for lightness of weight. However, the panels 20-21 and 30-31 can alternatively be solid or ventilated sheet-forms. FIG. 1 shows that each panel 20-21 and 30-31 comprises a rigid construction of grillwork. The panels 20-21 and 30-31 are hinged together to form a wing-like folding construction. That is, there is left wing unit 20-21 and a right wing unit 30-31, wherein left wing unit 20-21 comprises two panels 20 and 21 as the right wing unit 30-31 likewise comprises two other panels 30 and 31. Generally, the ramp 10 is symmetric about a folding axis between the left and right wing units 20-21 and 30-31. Each wing 20-21 or 30-31 unit comprises a main deck panel 20 or 30 connected to a folding leg/flap (ie., “leg”) panel 21 or 31. The deck panels 20 and 30 are relatively longer than the somewhat abbreviated leg panels 21 and 31.

Each deck panel 20 or 30 had inboard and outboard lateral edges 42 and 44 extending between inner and outer longitudinal edges 46 or 48. Similarly, each leg panel 21 or 31 has inboard and outboard lateral edges 52-53 and 54-55 extending between inner and outer longitudinal edges 56 and 58.

The left and right deck panels 20 and 30 are connected to each's same-side leg panel 21 and 31 by a folding connection 64 and 66 along the corresponding seam formed by the adjacent inner (longitudinal) edges 46 and 56 thereof. Suitable types of folding connections 64 and 66 include without limitation hinges (eg., as in piano-style hinges). Correspondingly, the left and right deck panels 20 and 30 are connected together by a comparable folding connection 62 along a central seam therebetween formed by the adjacent inboard (lateral) edges 42 thereof. Suitable types of folding connection 62 likewise include without limitation hinges.

Accordingly, the four panels consist of:
a left deck panel 20,
a right deck panel 30,
a left leg panel 21, and
a right leg panel 31.

It is preferred if the four panels 20, 21, 30 and 31 are connected to each other by three folding 62, 64 and 66 connections as follows: —
a central folding connection 62 interconnects the left and right deck panels 20 and 30 along the inboard edges 42 thereof,
a left-side leg connection 64 interconnects the left deck panel 20 and left leg panel 21 along the inner (longitudinal) edges 46 and 56 thereof, and
a right-side leg connection 66 interconnects the right deck panel 30 and right leg panel 31 along the inner (longitudinal) edges 46 and 56 of these too.

It is a design preference but without limitation to other suitable constructions that the panels 20-21 and 30-31 comprise a grillwork assembly as shown for providing suitable strength in a lightweight construction.

It is more preferential still, but not exclusively so, that the panels 20-21 and 30-31 comprise a grillwork construction of slender aluminum tubes and/or bar stock rigidly affixed together.

Each deck panel 20 and 30 comprises spaced stiles extending between spaced rails. The stiles serve at the inboard and outboard edges 42 and 44 of each deck panel 20 and 30 as the rails serve as the inner and outer (longitudinal) edges 46 and 48. Each deck panel 20 and 30 furthermore comprises a grillwork with longitudinally extending, spaced parallel chords intersecting and fixed together by laterally extending, spaced parallel webs.

The leg panels 21 and 31 differ as follows. FIG. 1 shows that the grillwork characteristic of the deck panels 20 and 30 is, in the leg panels 21 and 31, bounded in the outer longitudinal extreme by an outermost web 67. FIGS. 1 and 3 show that the stiles for the leg panels 21 and 31 (ie., the inboard and outboard longitudinal edges 52-53 and 54-55 for the leg panels 21 and 31) comprise a pair of telescoping sleeves 52 and 53, as well as 54 and 55, one of each of the pair of sleeves 52 and 53 or 54 and 55 being internal to the other being external. The sleeves 52 and 53 or 54 and 55 allow sliding adjustment of the length of the stiles for the leg panels 21 and 31 (ie., the inboard and outboard longitudinal edges 52-53 and 54-55 for the leg panels 21 and 31). The sleeves 52 and 53 or 54 and 55 are rigidly spaced apart to the outer rail (outer longitudinal edge 58) and hence form a slide assembly 52-55 and 58. Sliding the slide assembly 52-55 and 58 through extension and foreshortening strokes allows adjustment over the length of the leg panels 21 or 31 (ie., the distance between the inner and outer edges 56 and 58 of the leg panels 21 or 31) between extended and foreshortened extremes.

Each panel 20, 21, 30 and 31 has an upper face (in contrast to surface, since the faces are not solid but comprise the crisscross grillwork of the chords and webs) as well as a lower face. As described above, FIG. 6 shows the self-sustaining multi-collapsible loading ramp 10 in accordance with the invention in a fully collapsed or folded-up state. Each left and right leg panel 21 and 31 has been folded shut against its respective left and right deck panel 20 and 30.

That is, the lower faces of the left leg panel 21 and left deck panel 20 are folded shut against each other. Likewise, the lower faces of the right leg panel 31 and right deck panel 30 are folded shut against each other. Then also, the left and right deck panels 20 and 30 are folded shut against each other such their respective upper faces are shut against each other. As FIG. 6 shows, the leg panels 21 and 31 lie outside the deck panels 20 and 30 when the ramp 10 is in the fully folded-up state.

FIG. 3 through 6 show the ramp 10 in an intermediate state between the extremes of fully outspread and fully folded-up. Indeed, FIGS. 3 through 6 serve as a series of slides. However, the description that follows shall describe the sequence of steps to take to fold the ramp 10 out from the fully-folded-up state (ie., in reverse order of FIGS. 3 through 6).

Again, FIG. 6 shows the inventive loading ramp 10 in a fully collapsed or folded-up state. FIG. 5 shows that the right leg panel 31 is deployed relative to its right deck panel 30. The left deck panel 20 is folded up against right deck panel 30. The left leg panel 21 is folded up against the left deck panel 20. In sum, FIG. 5 shows that the right leg panel 31 is deployed relative to the right deck panel 30, with all the other panels 20 and 21 in a folded-up state. FIG. 5 also shows that the slide assembly 52-55 and 58 for the right leg panel 31 is slid to an extended extreme therefor (or something pretty near). The slide assembly 52-55 and 58 for the left leg panel 21 is slid to a foreshortened extreme therefor (or something close to).

FIG. 2 shows that the ramp 10 includes a flexible lanyard 68—in this example, a twisted steel cable—prevents the angle between a leg panel 21 or 31 and its same side deck panel 20 or 30 from opening up beyond an extreme, which extreme is determined by said lanyard 68. Aside from the extreme angle, FIG. 2 further shows that the fixed angle between a leg panel 21 or 31 and its same side deck panel 20 or 30 is adjustable by a strut 70. Each strut 70 (of either the left or right side, wherein right side is shown in FIG. 2) has a base end 72 that can be pinned tight to the outboard edge 44 of the same-side deck panel 20 or 30 in a number of selectable positions (eg., pin-holes).

Likewise, each strut 70 has a tip end 74 which can be pinned tight in a number of selectable positions (eg., pin-holes) in the outboard edge 54-55 of the same-side leg panel 21 or 31. Changing where the strut 70's tip end 74 is pinned to the leg panel 21 or 31 changes the slope of the deck panel(s) 20 and 30. Hence the foregoing provides one manner of adjusting the slope and height of the ramp 10's deck 20/30.

Moreover, as described previously in connection with FIGS. 1 and 3, the leg panels 21 and 31 have slide assemblies 52-55 and 58 that allow adjustment over the length of the leg panels 21 and 31 between extended and foreshortened extremes. Hence this provides another manner of adjusting the slope and height of the ramp 10's deck 20/30. In sum, the ramp 10's slope and height is adjustable, and FIG. 2 shows just a fraction of the range that is possible. Adjusting the height as well as slope of the ramp 10 is advantageous for making the inventive loading ramp 10 universal in service among large trucks to small, with their accordingly higher beds to lower beds.

FIG. 4 shows the left deck panel 20 folded out off the already-deployed right deck panel 30. FIG. 3 shows the left leg panel 21 folded out away from the earlier-deployed left deck panel 20. The left-side leg and deck panels 21 and 20 have a comparable (left-side) strut mechanism 70 as the right-side leg and deck panels 31 and 30 (and as described above in connection with FIG. 2).

FIG. 8 shows that the left and right leg panels 21 and 31 latch together for temporary purposes (as during use) by a latch mechanism 76, which is near street level. Hence the inventive self-sustaining ramp 10 folds out to make a self-sustaining, albeit asymmetric, A-frame structure.

FIG. 1 shows that the latch 76 unites the leg panels 21 and 31 in a common plane, with inboard edges 52-53 stationary alongside one another, in adjacent parallel axes, such that the leg panels 21 and 31 are in edge-to-edge juxtaposition. The leg panels 21 and 31 can be folded in and out in unison while latched together (and relative to the deck panels 20 and 30) because the leg panels' pivot axes (through folding connections 64 and 66) lie on a common, single axis.

In order to get the axes through folding connection 64 and 66 to line up on the common single axis, the deck panels 20 and 30 have to unfold relative to each other such that they are outspread in a common plane with one another. That way, the deck panels 20 and 30 present a uniform track surface thereacross.

Hence the struts 70 and latch mechanism 76 cooperatively form a locking system (70,76) as a whole for the ramp 10. The struts/latch mechanism 76 are operative between an unlocked extreme, which allows relative movement among the panels (eg., FIG. 6), and a locked extreme (ie., FIGS. 1 through 3) that both releasably locks the left and right deck panels 20 and 30 outspread so as to form said common ramp track as well as releasably locks the left and right leg panels 21 and 31 not only in a common plane relative to each other but also in a common, fixed angle of spread apartness relative to the left and right deck panels 20 and 30, respectively.

FIG. 2 shows, in solid lines, that the ramp 10 set up in an asymmetric A-frame to provide a track 20/30 between a low elevation 12 (or ground) and a high elevation 14 (or ground). The deck panels' outer edges 48 serve as low ground-engaging supports. Actually, FIG. 2 shows, when the dashed line depictions are studied as well, that the ramp 10 sets up in a range of outspread use states such that the ramp 10 forms a rigid, symmetric to asymmetric inverted-V frame structure. The upper faces of the deck panels 20 and 30 serve as the common ramp track. Overall, the ramp 10 is self-sustaining and, if made of sufficiently lightweight materials, the ramp 10 can be manually carried aloft by a single user from one use site to another while locked rigid so.

This is especially advantageous at a dealership for ATV's or a community trail ride with numerous ATV owners (this is not shown). One single ramp 10 can be carried from truck to truck to allow the loading/unloading of the respective ATV. The ramp 10's height is multiply adjustable to accommodate for various heights of pickup truck tailgates. The trucks need not be brought to the ramp 10 because, it is simpler to bring the ramp 10 to the trucks. When not in use, the ramp 10 can be stood to the side. It is an advantage that the ramp 10 stands erect when stood aside like that, and is not otherwise flat. If flat, when the ramp is set aside for a moment it either has to be laid on the ground or else left leaning against a truck. Both situations are problematical. An unused ramp laying on the ground in the chaos of a group ride might be unnoticed by someone an get driven over by either a truck or ATV. An unused ramp leaning against a truck might be unnoticed by the truck's driver, who might inadvertently put the truck in reverse and crumple the ramp. However, with a ramp 10 in accordance with the invention, it remains set up and self-sustaining while set aside. In such a state, the ramp 10 is no more likely to get run over or unnoticed as any of the ATV's.

FIGS. 1 and 2 show that, attached to optionally the deck panels 20 and 30 (as shown) and, or else, the leg panels 21 and 31 (not shown) are a series of tongue extensions 78 that serve as high ground-engaging supports. As mentioned before, the expected use environment has the high elevation structure 14 comprising the shelf-like projection of a pickup truck's dropped tailgate.

Regardless, preferably these high ground-engaging supports 78 are attached near the hinged inner edges 46 and 56 of the same-side deck and leg panel combination 20-21 and 30-31. Optionally, these high ground-engaging supports 78 are covered in a grip-enhancing coating to enhance frictional gripping between the high ground-engaging supports 78 and the high ‘ground’ structure 14 (eg., a marginal strip of a pickup truck's dropped tailgate along a ‘nose’ edge thereof, and as shown in FIGS. 1, 2 and 7).

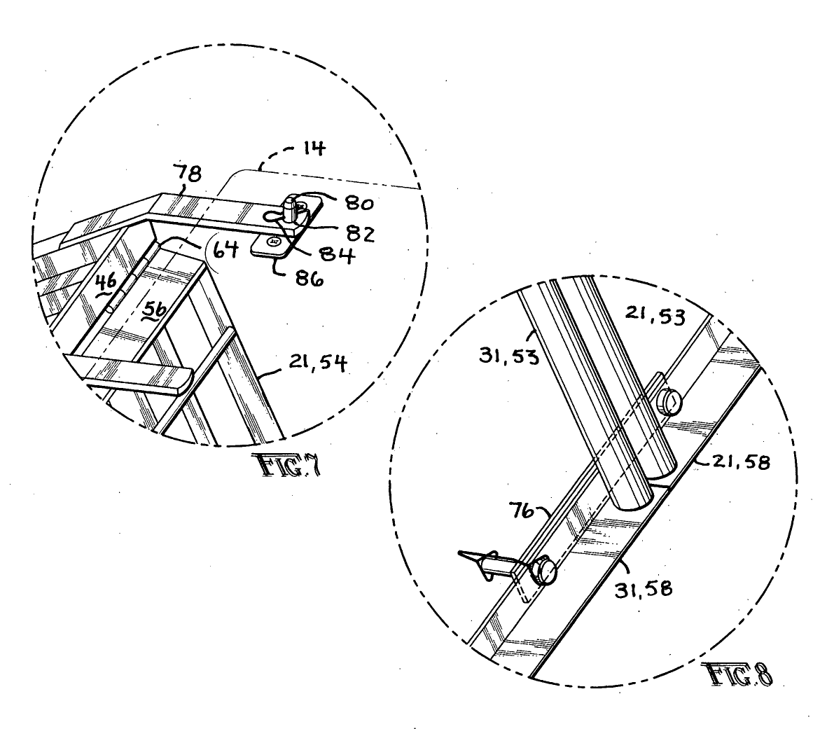

FIG. 7 shows that a further aspect of the invention comprises one or more projectors 80 for forming a hitching engagement between the high-ground supports 78 and the high ‘ground’ 14. Hence a hitch system in accordance with the invention comprises the projector 80 anchored on the high elevation 14, a socket 82 in the tongue extensions 78 that serve as the high ground-engaging supports 78, and a hairpin cotter 84 that serves as a retainer to prevent inadvertent withdrawal of the hitch post 80 from the socket 82.

Again, the typical intended high ground 14 is a pickup truck's dropped tailgate. The hitch post 80 is directly anchored not to the tailgate 14 but to a base plate 86, and the base plate 86 itself is directly (and securely) fastened to the pickup truck's tailgate 14 as shown.

The socket(s) 82 for the hitch post 80 are, more accurately, just holes that are bored all the way through the tongue extensions 76. During non-use, the hairpin cotter 84 can be stored engaged with the hitch post 80 on the tailgate 14 of the pickup truck.

FIG. 1 shows better one aspect of the invention. Namely, that the series of high-ground engaging supports 78 which engage the shelf-like projection of a pickup truck's dropped tailgate 14 allow ready transit of the transfer load thereover while it traverses from high elevation 14 to low 12, or vice versa. It is a further aspect of the invention that adaptations for the inventive hitch 80 be incorporated in at least two or more of the high ground-engaging supports 78 in accordance with the invention. Such would require outfitting the pickup truck's tailgate 14 with the hitch post 80 by way of its base plate 86 beforehand. However, the positive locking that is achieved between the hitched together ramp 10 and tailgate 14 prevents not only lateral displacement therebetween but also vertical 20—separation therebetween.

In other words, the positively hitched ramp 10 and tailgate 14 cooperatively prevent the tailgate 14 from sinking relative to the ramp 10 whenever the tailgate 14 supports more (up to all) of the weight of the transfer load than the ramp 10.

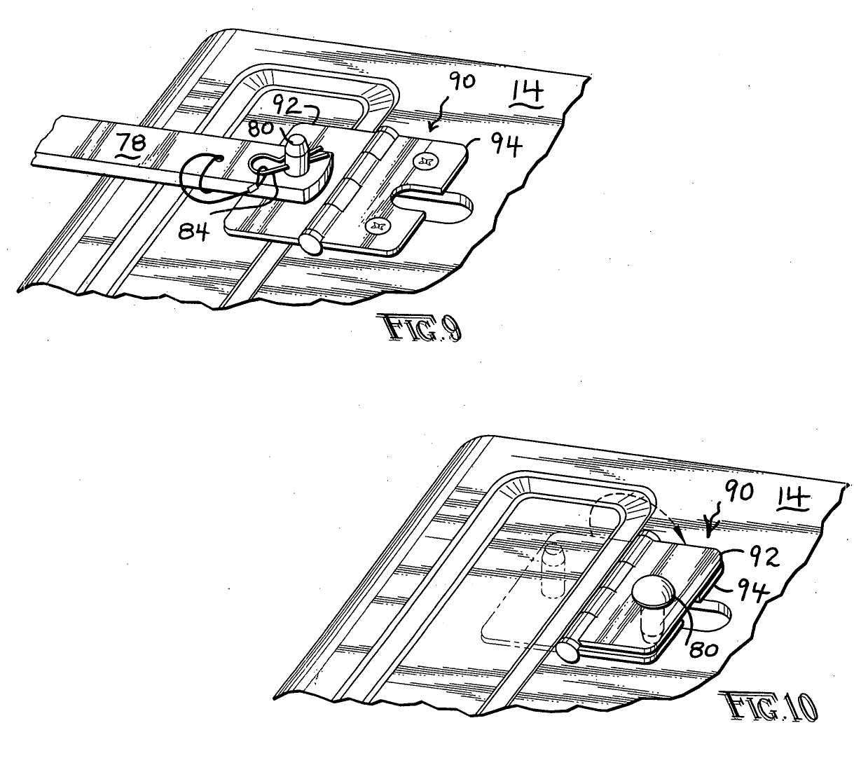

FIGS. 9 and 10 show a further enhancement in accordance with the invention. FIG. 9 an enlarged scale view of detail in FIG. 7, except detail lines are not drawn in encircling the detail as such detail lines are used in FIG. 1. Also, the matters shown in FIG. 9 are not truly shown in FIG. 7.

Nevertheless, FIGS. 9 and 10 show an alternate embodiment of a mounting base 90 in accordance with the invention for mounting the projector 80. The mounting base 90 comprises a hinge having a hinge pin connecting a pair of folding leafs 92 and 94, one leaf 92 being adapted for anchoring to (eg., as by rivets) to the pickup truck's dropped tailgate 14. The mounting base 90 is adapted for conversion between a use state (eg., FIG. 9), which has the projector 80 upright, and a retracted state (eg., FIG. 10), which has the projector 80 buried into the interior of the pickup truck's tailgate 14. That way, during non-use, the projector 80 is out of the way from causing inconveniences.

To make way for the projector, the pickup truck's tailgate's inside wall is drilled out with an oversize aperture as shown.

FIG. 9 shows that preferably the projector 80 is retained to high ground-engaging support 78 by hairpin cotter 84. As can be reckoned by FIG. 10, preferably the hinge of the mounting base keeps itself closed under its own power by way of the hinge leafs 92 and 94 being magnetic, with the magnetism thereof being arranged such that the two hinge leafs 92 and 94 are magnetically-attracted to each other in the position shown.

The invention having been disclosed in connection with the foregoing variations and examples, additional variations will now be apparent to persons skilled in the art. The invention is not intended to be limited to the variations specifically mentioned, and accordingly reference should be made to the appended claims rather than the foregoing discussion of preferred examples, to assess the scope of the invention in which exclusive rights are claimed.

I claim:

1. A self-sustaining multi-collapsible loading ramp for a transfer load to traverse between a low ground and a high ground, and convertible between a range of collapsed states and a range of outspread use states, comprising:
a left pair of panels comprising a left leg panel and left deck panel;
a right pair of panels comprising a right leg panel and right deck panel, which is connected to the left deck panel by a medial folding connection;
wherein each panel has inboard and outboard lateral edges extending between inner and outer longitudinal edges, and wherein each panel has relatively upper and lower faces relative to the range of outspread use states such that the transfer load traverses across the deck panels' upper faces;
said medial folding connection defining a pivot axis between the inboard lateral edges of the left and right deck panels for folding between one state which has the deck panels outspread to form a common ramp track and another state which has the deck panels fully folded-up in adjacent parallel planes with the relatively upper faces thereof in face-to-face juxtaposition;
a left folding connection between the left leg and deck panels for folding from fully folded-up, wherein the left leg and deck panels are in adjacent parallel planes with the relatively lower faces thereof in face-to-face juxtaposition, to a range of angles of spread apartness, and conversely;
a right folding connection between the right leg and deck panels for folding from fully folded-up, wherein the right leg and deck panels are in adjacent parallel planes with the relatively lower faces thereof in face-to-face juxtaposition, to a range of angles of spread apartness, and conversely;
a locking system operative between an unlocked extreme, which allows relative movement among the panels, and a locked extreme that both releasably locks the left and right deck panels outspread so as to form said common ramp track as well as releasably locks the left and right leg panels not only in a common plane relative to each other but also in a common, fixed angle of spread apartness relative to the left and right deck panels, respectively;
wherein the range of outspread use states for said ramp comprises the locking system locked such that said ramp forms a rigid, symmetric to asymmetric inverted-V frame structure, with the deck panels' upper faces serving as the common ramp track, whereby said ramp is self-sustaining and, if made of sufficiently lightweight materials, can be manually carried aloft by a single user from one use site to another while locked rigid so.

2. The self-sustaining multi-collapsible loading ramp of claim 1 wherein:
said locking system comprises mechanical locking apparatus having a locked position which locks the inboard lateral edges of the left and right leg panel in adjacent parallel axes, thereby in edge-to-edge juxtaposition.

3. The self-sustaining multi-collapsible loading ramp of claim 2 wherein said locking system mechanism further comprises:
a left strut between the left leg and deck panels and a right strut between the right leg and deck panels, wherein said struts releasably lock the respective leg and deck panels therefor in fixed angles of spread apartness.

4. The self-sustaining multi-collapsible loading ramp of claim 1 wherein:
said locking system comprises a locking mechanism between the left and right leg panels having an unlocked state allowing relative movement between the left and right deck panels and a locked state which directly locks said left and right leg panels not only in a common plane relative to each other but also in a common, albeit unfixed, angle of spread apartness relative to the left and right deck panels, respectively;
whereby said locking mechanism's locked state indirectly locks the left and right deck panels outspread so as to form said common ramp track.

5. The self-sustaining multi-collapsible loading ramp of claim 4 wherein:
said locking system further comprises a left strut between the left leg and deck panels and a right strut between the right leg and deck panels;
said struts cooperating with said locking mechanism that directly locks said left and right leg panels in the common, albeit unfixed, angle of spread apartness relative to the left and right deck panels, to fix said common angle of spread apartness.

6. The self-sustaining multi-collapsible loading ramp of claim 4 wherein said locking mechanism that directly locks said left and right leg panels in the common, albeit unfixed, angle of spread apartness relative to the left and right deck panels, comprises:
mechanical locking apparatus having a locked position which locks the inboard lateral edges of the left and right leg panel in adjacent parallel axes, thereby in edge-to-edge juxtaposition.

7. The self-sustaining multi-collapsible loading ramp of claim 1 further comprising:
high ground-engaging supports extending horizontally from the ramp proximate the left and right deck panels' inner longitudinal edges and adapted for lapping onto a margin of the high ground proximate a nose edge thereof.

8. A combination of a hitch system with a self-sustaining multi-collapsible loading ramp in accordance with claim 7, said hitch system comprising:
said high ground-engaging supports being formed with a plurality of sockets; and
a plurality of projectors for removably extending into said sockets and adapted to be anchored to and distributed along said margin of the high ground that is proximate the nose edge thereof;
whereby insertion of the projectors in the sockets forms a hitch connection between the ramp and said margin of the high ground that is proximate the nose edge thereof in order to constrain relative displacement in a horizontal plane between the ramp's deck panel's inner longitudinal edges and said high ground's nose edge.

9. The combination of claim 8 wherein said hitch system further comprises:
said high ground-engaging supports comprising one or more horizontally-projecting webs, which are formed with a plurality of apertures that serve as the plurality of hitch sockets;
said plurality of projectors being elongated sufficiently to extend through the plurality of sockets to elevations clearing the one or more webs and formed with crosswise retainer-receiving holes at elevations above the one or more webs; and
a plurality of retainers for removably inserting through the retainer-receiving holes of the plurality of projectors whereby said retainers are adapted to constrain relative vertical displacement between the ramp's deck panel's inner longitudinal edges and said high ground's nose edge.

10. The combination of claim 8 wherein said hitch system further comprises:
a plurality of projector-retractable mounting systems for said plurality of projectors, adapted for mounting at distributed locations along said margin of the high ground that is proximate the nose edge thereof, and convertible between a use state with said projector upright and a retracted state with said projector buried at least in part below the elevation of said margin of the high ground that is proximate the nose edge thereof.

11. The combination of claim 10 wherein:
said projector-retractable mounting systems comprise hinges having a hinge pin connecting a pair of folding leafs, one of which is adapted for anchoring in the high ground in the margin thereof that is proximate the nose edge thereof and the other which carries the projector.

12. The self-sustaining multi-collapsible loading ramp of claim 1 wherein:
wherein said left and right deck panels' outer longitudinal edges when said ramp is in the range of outspread use states are cooperatively aligned as to be adapted to serve as low ground-engaging supports.

13. The self-sustaining multi-collapsible loading ramp of claim 1 wherein:
said leg panels comprise an adjustable construction that is adjustable between elongated and foreshortened extremes in the longitudinal direction in order to accommodate relative differences in elevation between said low and high ground.

14. The self-sustaining multi-collapsible loading ramp of claim 13 wherein:
said leg panels comprise a framework construction including stiles and riles, and wherein said stiles comprise telescopic members adapted to afford adjustability for leg panels in the longitudinal direction between said elongated and foreshortened extremes.
